(19) United States
(12) Patent Application Publication
(10) Pub. No.: US 2009/0239413 A1
(43) Pub. Date: Sep. 24, 2009

(54) REINFORCED PATCH PANEL FRAME WITH REAR MOUNTED MODULES

(76) Inventor: Luc MILETTE, Montreal (CA)

Correspondence Address: GOUDREAU GAGE DUBUC, 2000 MCGILL COLLEGE, SUITE 2200, MONTREAL, QC, H3A 3H3, CA

(21) Appl. No.: 12/407,864

(22) Filed: Mar. 20, 2009

Related U.S. Application Data
(60) Provisional application No. 61/038,238, filed on Mar. 20, 2008.

(51) Int. Cl. H01R 13/00; H01R 13/518; H01R 13/514

(52) U.S. Cl. 439/540.1

(57) ABSTRACT

There is provided a patch panel for mounting thereto a plurality of keystone style modular jacks each comprising a forward portion having a plug receiving opening moulded therein. The patch panel comprises a flat frame comprising a first plurality of like rectangular openings, each one of the first plurality of openings adapted to receive one of the plurality of jacks; and a flat panel arranged behind the frame substantially co-planar therewith and comprising a second plurality of like rectangular openings, each one of the second plurality of openings aligned with and of dimensions greater than a respective one of the first plurality of openings. The panel is spaced from the frame by a distance for accommodating the forward portion of the plurality of jacks when the plurality of jacks are received in aligned pairs of the first and the second plurality of openings. Also, when one of the plurality of jacks is positioned within one of the second plurality of openings, the plug receiving opening is accessible via one of the first plurality of openings.

### CROSS REFERENCE TO RELATED APPLICATIONS

This application claims priority from U.S. provisional application Ser. No. 61/038,238, filed on Mar. 20, 2008, which is incorporated herein in its entirety by reference.

### FIELD OF THE INVENTION

The present invention relates to a reinforced patch panel frame with rear mounted modules.

### BACKGROUND OF THE INVENTION

Although keystone style modular jacks are well known in the art, patch panel frames typically fail to accommodate keystone style modular jacks made in accordance with industry standards, especially at the rear of the patch panel frame due to the width of the modular jack. To overcome these difficulties, prior art assemblies use patch panels, typically one-piece mould die cast, that have a thickness equal to the width of the modular jack in order to accommodate the latter, thus resulting in thick and bulky designs. Other mounting assemblies use modular multi-port modules tailored to a specific performance. Alternatively, the keystone style modular jacks are accommodated on faceplates or mounting brackets attached to the patch panel frame. Still, a major drawback of these assemblies is the complex and expensive nature of the design and construction. Other prior art patch panel assemblies accommodate the keystone style modular jacks on a single frame in order to maximize patch panel density, thus saving money and rack space. Although this results in patch panels of simple construction, in high density applications these structures suffer from a low strength and structural rigidity, as the frame is not reinforced and is thus susceptible to damage due to bending forces or the like.

What is therefore needed, and an object of the present invention, is a simplified patch panel assembly that can accommodate a standard keystone modular jack at the rear side of the patch panel while providing structural strength and eliminating costly tooling for plastic or die casting mould.

### SUMMARY OF THE INVENTION

More specifically, in accordance with the present invention, there is provided a patch panel for mounting thereto a plurality of keystone style modular jacks each comprising a forward portion having a plug receiving opening moulded therein. The patch panel comprises a flat frame comprising a first plurality of like rectangular openings, each one of the first plurality of openings adapted to receive one of the plurality of jacks; and a flat panel arranged behind the frame substantially co-planar therewith and comprising a second plurality of like rectangular openings, each one of the second plurality of openings aligned with and of dimensions greater than a respective one of the first plurality of openings. The panel is spaced from the frame by a distance for accommodating the forward portion of the plurality of jacks when the plurality of jacks are received in aligned pairs of the first and the second plurality of openings. Also, when one of the plurality of jacks is positioned within one of the second plurality of openings, the plug receiving opening is accessible via one of the first plurality of openings.

Still in accordance with the present invention, there is further provided a patch panel for mounting thereto a plurality of keystone style modular jacks each comprising a forward portion having a plug receiving opening moulded therein. The patch panel comprises a flat frame comprising a first plurality of like rectangular openings, each one of the first plurality of openings adapted to receive one of the plurality of jacks; and a flat panel arranged in front of the frame substantially co-planar therewith and comprising a second plurality of like rectangular openings, each one of the second plurality of openings aligned with and of dimensions smaller than one of the first plurality of openings. The panel is spaced from the frame by a distance for accommodating the forward portion of the plurality of jacks when the plurality of jacks is received in aligned pairs of the first and the second plurality of openings. Also, when one of the plurality of jacks is positioned within one of the first plurality of openings, the plug receiving opening is accessible via one of the second plurality of openings.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

FIG. 1 is a rear perspective view of a keystone patch panel in accordance with an illustrative embodiment of the present invention;

FIG. 2 is a detailed rear perspective view of a frame and a back panel of a keystone patch panel in accordance with an illustrative embodiment of the present invention;

FIG. 3A is a perspective view of a keystone modular jack in accordance with an illustrative embodiment of the present invention;

FIG. 3B is a side view of a keystone modular jack in accordance with an illustrative embodiment of the present invention;

FIG. 4 is a detailed rear perspective view of a keystone modular jack mounted in a keystone patch panel in accordance with an illustrative embodiment of the present invention;

FIG. 5 is a front perspective view of a keystone patch panel in accordance with an alternative illustrative embodiment of the present invention;

FIG. 6 is a detailed front perspective view of a frame and a front panel of a keystone patch panel in accordance with an alternative illustrative embodiment of the present invention; and

FIG. 7 is a detailed front perspective view of a keystone modular jack mounted in a keystone patch panel in accordance with an alternative illustrative embodiment of the present invention.

### DETAILED DESCRIPTION OF THE ILLUSTRATIVE EMBODIMENTS

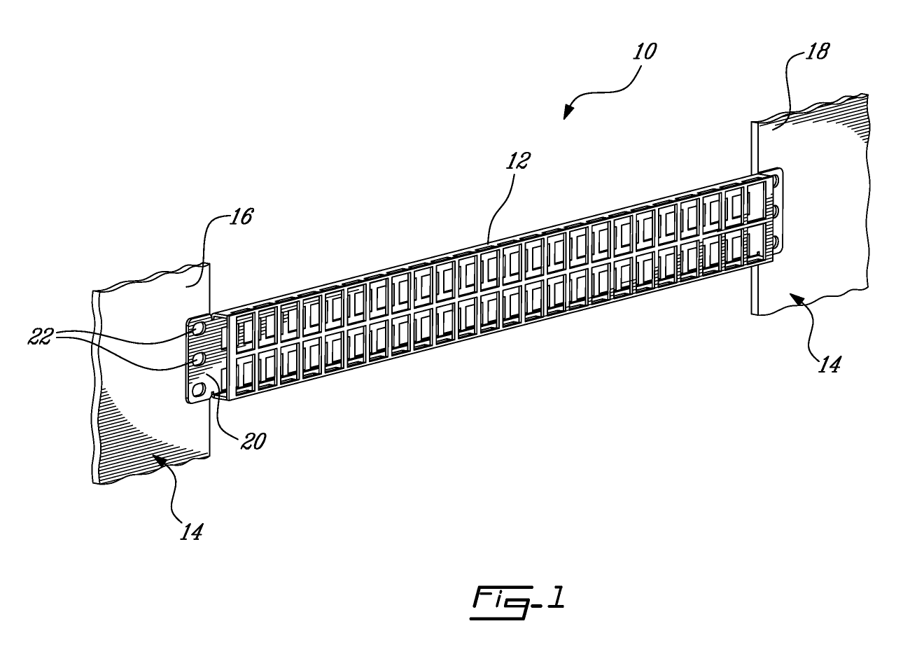

Referring now to FIG. 1, and in accordance with an illustrative embodiment of the present invention, a patch panel assembly, generally referred to using the reference numeral 10, will now be described. The patch panel assembly 10 comprises at least one keystone patch panel 12 mounted to a standard network rack 14 (e.g. EIA/TIA 19-inch rack) comprising two spaced vertical side rails 16 and 18. Mounting plates as in 20 are formed integrally with the keystone patch panel 12 at each extremity thereof and comprise mounting apertures as in 22, which allow the keystone patch panel 12 to be mounted to the rails 16 and 18 using fasteners such as nuts, bolts, and the like (not shown).

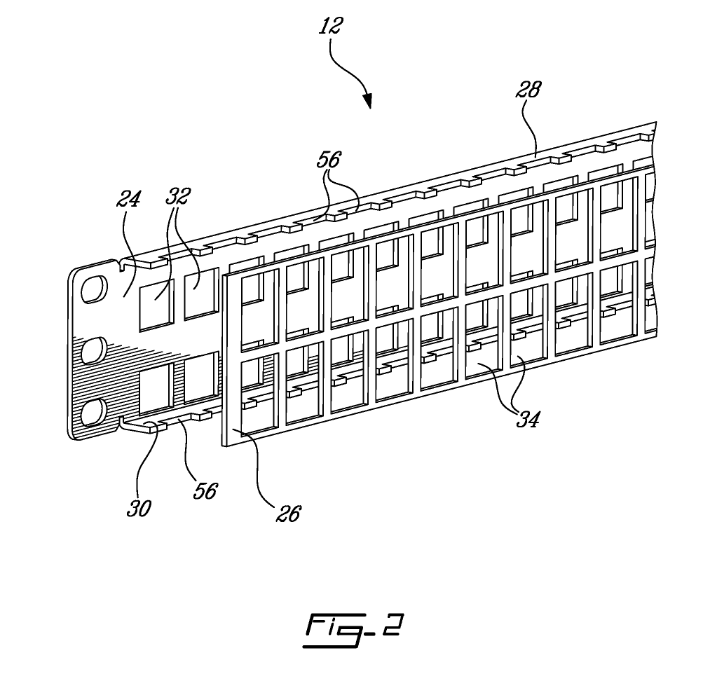

Referring now to FIG. 2, the patch panel 12 illustratively comprises a planar frame 24 and a flat panel 26 fixedly attached substantially co-planar to a rear face of the frame 24 for providing reinforcement to the patch panel 12. For this purpose, a top strip 28 and a bottom strip 30 respectively project rearwardly from an upper edge and a bottom edge (both not shown) of the frame 24 at a substantially right angle. The panel 26 is illustratively attached to the rear of the frame 24 by respectively securing (using a suitable attachment method, such as welding or the like) an upper edge and a lower edge (both not shown) of the panel 26 to the top strip 28 and to the bottom strip 30.

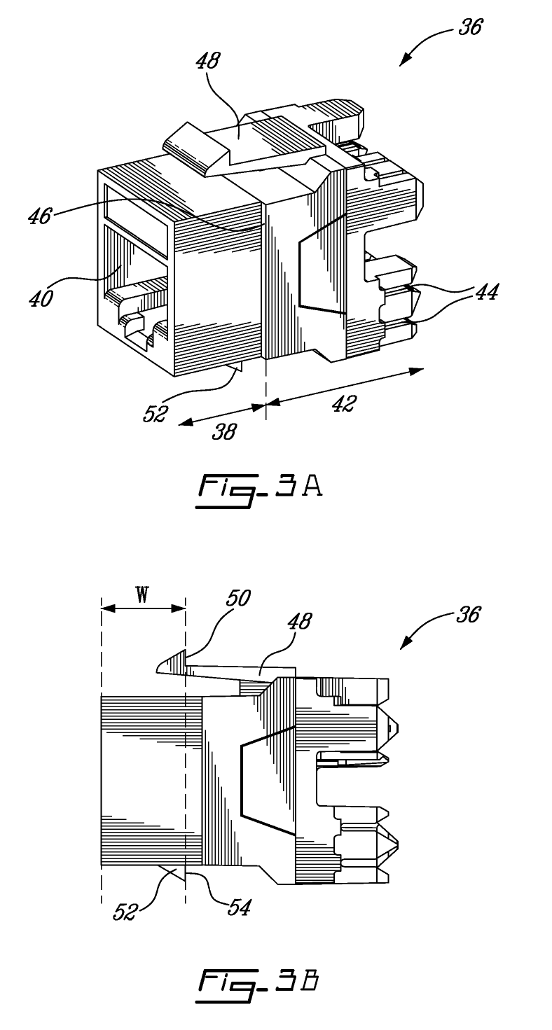

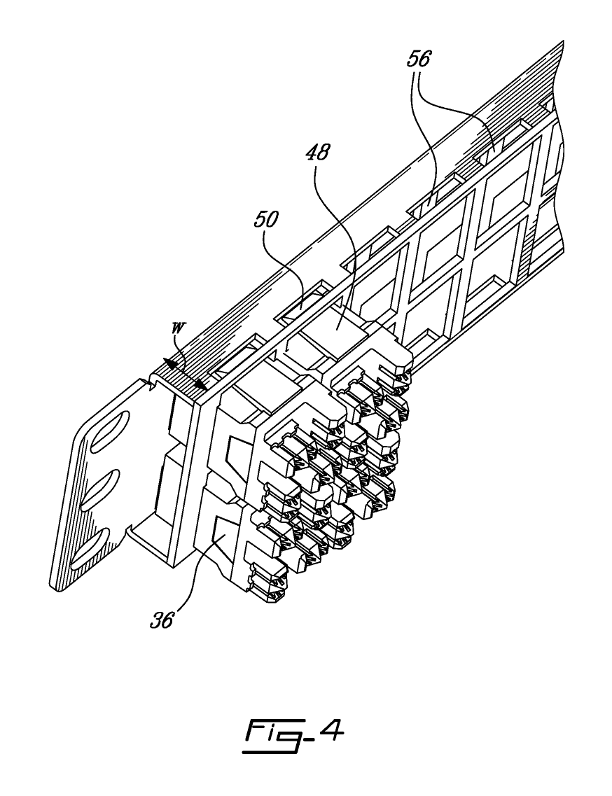

Referring now to FIG. 3A, FIG. 3B, and FIG. 4 in addition to FIG. 2, the frame 24 and the panel 26 respectively comprise a plurality of aligned openings as in 32 and 34, which are each sized and shaped to receive therein modular jacks as in 36. The modular jacks as in 36 are illustratively keystone modular jacks but it will be apparent to a person skilled in the art that other types of latching mechanisms, such as the AMP Netconnect™ style jacks or the like, could be used without departing from the scope of the present invention. As will also be apparent to a person skilled in the art, the modular jack 36 is inserted from the rear of the patch panel 12 substantially straight into a pair of aligned openings as in 32 and 34. As such, the distance between two vertically stacked modular jacks as in 36 is minimized.

Still referring to FIG. 3A, FIG. 3B, and FIG. 4 in addition to FIG. 2, a keystone modular jack as in 36 typically comprises a forward portion 38 having moulded therein a plug receiving opening 40 adapted to receive a mating plug (not shown), for example an RJ-45 style plug, and a rearward portion 42 having a plurality of terminals 44 for terminating individual conductors of a cable (not shown). Illustratively, the forward portion 38 is separated from the rearward portion 42 by a retaining ridge 46 extending along the contour of the rearward portion 42, such a contour being typically slightly larger than that of the forward portion 38. Thus, it is desirable for the openings as in 32 of the frame 24, which receive the forward portion 38 of the keystone modular jacks as in 36, to be substantially smaller than the openings as in 34, which receive the rearward portion 42. In this manner, the patch panel 12 properly accommodates the size and shape of the keystone modular jacks as in 36, which are secured within the openings as in 32 and 34 by the retaining ridge 46 bearing against the rear surface (not shown) of the panel 26. Still, as mentioned herein above, the combination of the frame 24 with the panel 26 is provided to improve the structural rigidity of the patch panel 12. Additionally, the front face of the frame 24 is provided for aesthetic purposes. Thus, the openings as in 32 could be larger than the openings as in 34, as desired, while still providing the requisite reinforcement. Alternatively, a single opening 32 could encompass a plurality (e.g. two (2)) of openings as in 34, thus allowing a plurality of plug receiving openings as in 40 to be accessible from the front of the patch panel 12 via a single opening 32.

Still referring to FIG. 3A, FIG. 3B, and FIG. 4, it is further desirable to provide sufficient spacing to accommodate the width W of the forward portion 38 when the keystone modular jack 36 is mounted to the rear of the patch panel 12. For this purpose, the strips 28 and 30 each extend away from the frame 24 by a distance substantially equal to W, such that, when the panel 26 is attached to the frame 24, a spacing W is provided between the panel 26 and the frame 24 to accommodate the keystone modular jack 36 inserted into the openings 34 and 32. In this manner, when the keystone modular jack 36 is mounted to the patch panel 12, the front of the keystone modular jack 36 will be flush with the front surface of the frame 24, with the plug receiving opening 40 being accessible via the opening 32. Alternatively, the width W may be selected so that the keystone modular jack 36 is slightly recessed into or protrudes from the frame 24.

Still referring to FIG. 3A, FIG. 3B, and FIG. 4, the keystone modular jack 36 further comprises on an upper surface thereof a forwardly extending cantilevered latch arm 48 (having at a distal end thereof a stop surface 50) and on a lower surface thereof a raised angled rib 52 (having a stop surface 54) for securing the keystone modular jack 36 to the patch panel 12. In order to accommodate the latch 48 and the rib 52, the top strip 28 and the bottom strip 30 of the frame 24 each comprise a plurality of recesses as in 56. As will now be apparent to a person skilled in the art, when the keystone modular jack 36 is mounted to the patch panel 12, the latch 48 and the rib 52 each engage their respective recesses as in 56 with the stop surfaces 50 and 54 respectively engaging a rearward edge of the respective recesses 56, thus further securing the keystone modular jack 36 to the patch panel 12.

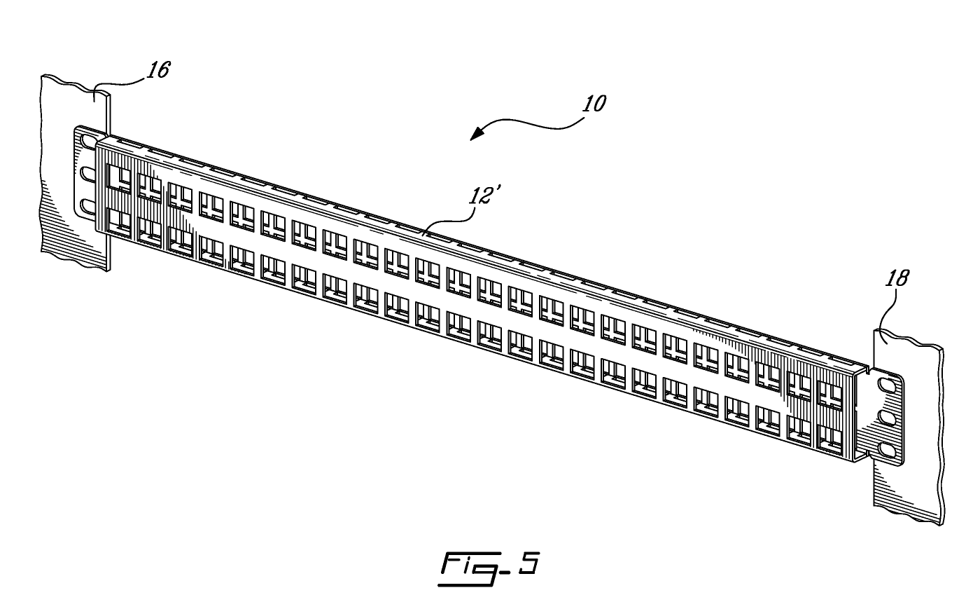

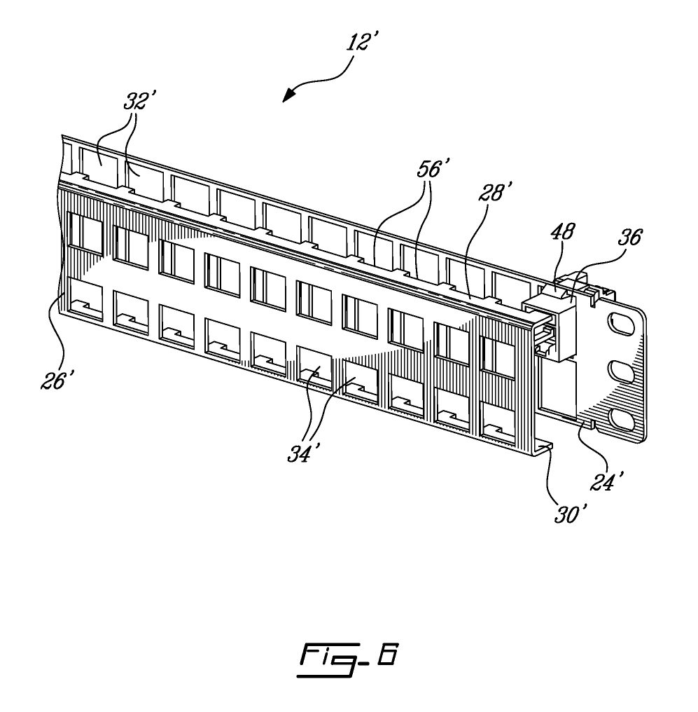

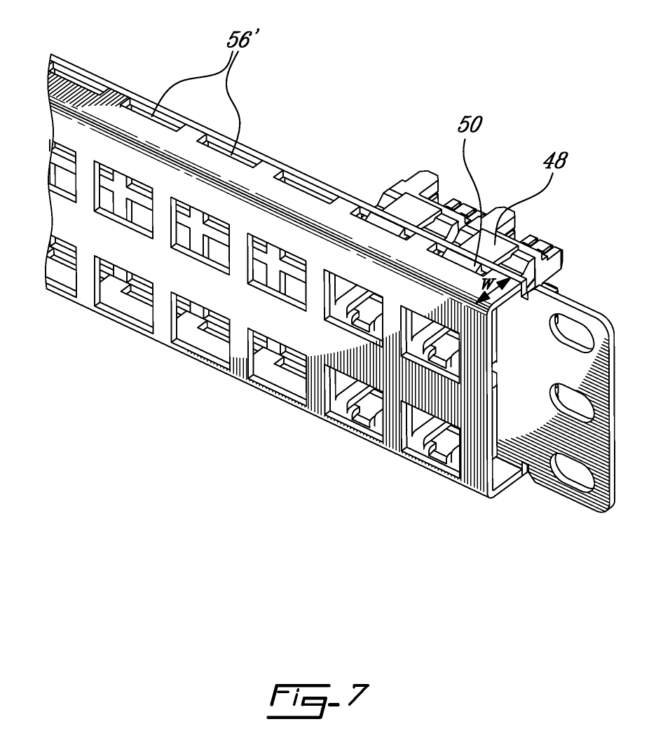

Referring now to FIG. 5, FIG. 6 and FIG. 7, and according to an alternative illustrative embodiment of the present invention, a patch panel 12′ may be provided with a flat panel 26′ mounted co-planar to a front face of a planar frame 24′. Similarly to the previous embodiment, the frame 24′ and the panel 26′ are respectively provided with aligned openings as in 32′ and 34′ sized and shaped to receive therein the keystone modular jack 36. As the panel 26′ is mounted in front of the frame 24′, the openings as in 34′ illustratively receive therein the forward portion (reference 38 in FIG. 3A) of the keystone modular jack 36 while the openings as in 32′ illustratively receive therein the rearward portion (reference 42 in FIG. 3A) and, as such, the openings as in 34′ are substantially smaller than the openings as in 32′. Again, as mentioned previously herein above, due to the partially aesthetic nature of the front face of the panel 26′, the openings as in 34′ could each be larger than the openings as in 32′ or alternatively a single opening 34′ could encompass a plurality (e.g. two (2)) of openings as in 32′, as desired.

Still referring to FIG. 6 and FIG. 7, the panel 26′ comprises a top strip 28′ and a bottom strip 30′, which, similarly to strips 28 and 30 described herein above, enable the panel 26′ to be fixedly attached to the front of the frame 24′ using a suitable method (e.g. welding). The strips 28′ and 30′ also extend at a substantially right angle rearwardly from the panel 26′ by a distance W substantially equal to the width W of the forward portion (reference 38 in FIG. 3A) of the keystone modular jack 36. The top strip 28′ and the bottom strip 30′ of the panel 26′ further comprise a plurality of recesses as in 56′, which enable the latch 48 and rib (reference 52 in FIG. 3A) of the keystone modular jack 36 to be engaged therein (similarly to the previous embodiment) when the keystone modular jack 36 is inserted into the openings 32′ and 34′ of the patch panel 12′.

Referring back to FIG. 1 and FIG. 5, the present invention advantageously provides a patch panel assembly 10 that accommodates standard keystone modular jacks as in 36 at the rear of the patch panel 12 using a simple design and construction, in which the thickness of the patch panel 12 is of no significance, thus proving less expensive than keystone patch panels currently known in the art. Also, providing a frame (reference 24 in FIG. 2) having a panel (reference 26 in FIG. 2) attached thereto significantly improves the structural strength and rigidity of the patch panel assembly 12, which can thus advantageously sustain strong bending forces or the like without damage thereto.

Although the present invention has been described hereinabove by way of specific embodiments thereof, it can be modified, without departing from the spirit and nature of the subject invention as defined in the appended claims.

What is claimed is:

1. A patch panel for mounting thereto a plurality of keystone style modular jacks each comprising a forward portion having a plug receiving opening moulded therein, the patch panel comprising:
a flat frame comprising a first plurality of like rectangular openings, each one of said first plurality of openings adapted to receive one of the plurality of jacks; and
a flat panel arranged behind said frame substantially co-planar therewith and comprising a second plurality of like rectangular openings, each one of said second plurality of openings aligned with and of dimensions greater than one of said first plurality of openings;
wherein said panel is spaced from said frame by a distance for accommodating the forward portion of the plurality of jacks when the plurality of jacks are received in aligned pairs of said first and said second plurality of openings;
and further wherein when one of the plurality of jacks is positioned within one of said second plurality of openings, the plug receiving opening is accessible via one of said first plurality of openings.

2. A patch panel for mounting thereto a plurality of keystone style modular jacks each comprising a forward portion having a plug receiving opening moulded therein, the patch panel comprising:
a flat frame comprising a first plurality of like rectangular openings, each one of said first plurality of openings adapted to receive one of the plurality of jacks; and
a flat panel arranged in front of said frame substantially co-planar therewith and comprising a second plurality of like rectangular openings, each one of said second plurality of openings aligned with and of dimensions smaller than one of said first plurality of openings;
wherein said panel is spaced from said frame by a distance for accommodating the forward portion of the plurality of jacks when the plurality of jacks are received in aligned pairs of said first and said second plurality of openings;
and further wherein when one of the plurality of jacks is positioned within one of said first plurality of openings, the plug receiving opening is accessible via one of said second plurality of openings.
